(19) United States
(12) Patent Application Publication
(10) Pub. No.: US 2008/0231507 A1
(43) Pub. Date: Sep. 25, 2008

(54) METHOD AND SYSTEM FOR NAVIGATING TO A COMMON POINT OF INTEREST BASED ON THE LOCATIONS OF MULTIPLE GPS RECEIVERS

(76) Inventors: ERIK J. BURCKART, Raleigh, NC (US); Andrew Ivory, Durham, NC (US); Aaron K. Shook, Morrisville, NC (US)

Correspondence Address: DILLON & YUDELL LLP, 8911 N. CAPITAL OF TEXAS HWY., SUITE 2110, AUSTIN, TX, 78759, US

(21) Appl. No.: 11/689,353

(22) Filed: Mar. 21, 2007

(51) Int. Cl. G01S 5/14; G01C 21/30; G01S 1/02

(52) U.S. Cl. 342/357.08; 701/209

(57) ABSTRACT

A method of navigating to a common point of interest (POI) based on the locations of multiple global positioning system (GPS) receivers. In a first GPS receiver, an identifier of a second GPS receiver is selected from a list of pre-defined GPS receiver identifiers stored within the first GPS receiver. The first GPS receiver exchanges coordinates with the second GPS receiver. If the location of the second GPS receiver is the POI, the first GPS receiver calculates and displays navigational directions to the location of the second GPS receiver. If a location other than the second GPS receiver is the POI, the first GPS receiver calculates and displays multiple convenient meeting points based on pre-defined preferences. When one of the meeting points is selected, the first GPS receiver sends the coordinates to the other GPS receivers, and the first GPS receiver calculates and displays navigational directions to the meeting point.

### BACKGROUND OF THE INVENTION

1. Technical Field

The present invention relates in general to navigation systems and in particular to global positioning system (GPS) receivers. Still more particularly, the present invention relates to an improved method and system for navigating to a common point of interest (POI) based on the locations of GPS receivers.

2. Description of the Related Art

The Global Positioning System (GPS) is a Global Navigation Satellite System (GNSS) that utilizes satellites, which transmit signals from a medium Earth orbit to enable a GPS receiver to determine the location, speed, and direction of movement of the GPS receiver relative to the Earth. Furthermore, GPS satellites also provide precise time reference signals. A GPS receiver utilizes signals from three or more GPS satellites to calculate the position of the GPS receiver via a triangulation process. In the user segment (US) of the GPS system, GPS receivers typically comprise an antenna, which is tuned to the frequencies transmitted by the satellites, multiple receiver-processors, a highly-stable clock (e.g., a crystal oscillator), and a display device.

Conventionally, each user of a GPS receiver can use the receiver to obtain directions to meet one or more additional people at a convenient location or a common point of interest (POI). These people may also be equipped with GPS receivers. Typically, each user would need to initially contact each of the other users to decide upon a common POI and subsequently program the location of the POI into a GPS receiver to obtain directions to the POI. The coordination costs (i.e., initial communication and manual data entry times) associated with such a system increase dramatically as the number of users involved increases.

### SUMMARY OF AN EMBODIMENT

Disclosed are a method, system, and computer readable-medium for navigating to a common point of interest (POI) based on the locations of multiple global positioning system (GPS) receivers. A user of a first GPS receiver selects identifiers of one or more GPS receivers, including an identifier of a second GPS receiver, from a list of multiple pre-defined GPS receiver identifiers stored within the first GPS receiver. Each pre-defined GPS receiver identifier stored within the first GPS receiver corresponds to a personal contact of the user of the first GPS receiver. The first GPS receiver exchanges coordinates with the second GPS receiver. If the location of the second GPS receiver is the desired meeting point (i.e., the common POI), the first GPS receiver sends the coordinates of the second GPS receiver to the GPS receivers that correspond to each of the selected GPS receiver identifiers, and the first GPS receiver calculates and displays navigational directions to the location of the second GPS receiver. If a second location, other than the second GPS receiver, is the common POI, the first GPS receiver calculates and displays a list of multiple convenient potential meeting points based on pre-defined meeting preferences. When one of the meeting points is selected, the first GPS receiver defines the selected meeting point as the common POI, sends the coordinates of the common POI to the GPS receivers that correspond to each of the selected GPS receiver identifiers, calculates navigational directions to the common POI, and displays the navigational directions.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of a first global positioning system (GPS) receiver and a second GPS receiver in relation to a common point of interest (POI), according to an embodiment of the present invention; and

FIG. 2 is a high level logical flowchart of an exemplary method of navigating to a common POI based on the locations of multiple GPS receivers, according to an embodiment of the invention.

### DETAILED DESCRIPTION OF AN ILLUSTRATIVE EMBODIMENT

The present invention provides a method, system, and computer readable-medium for navigating to a common point of interest (POI) based on the locations of multiple global positioning system (GPS) receivers.

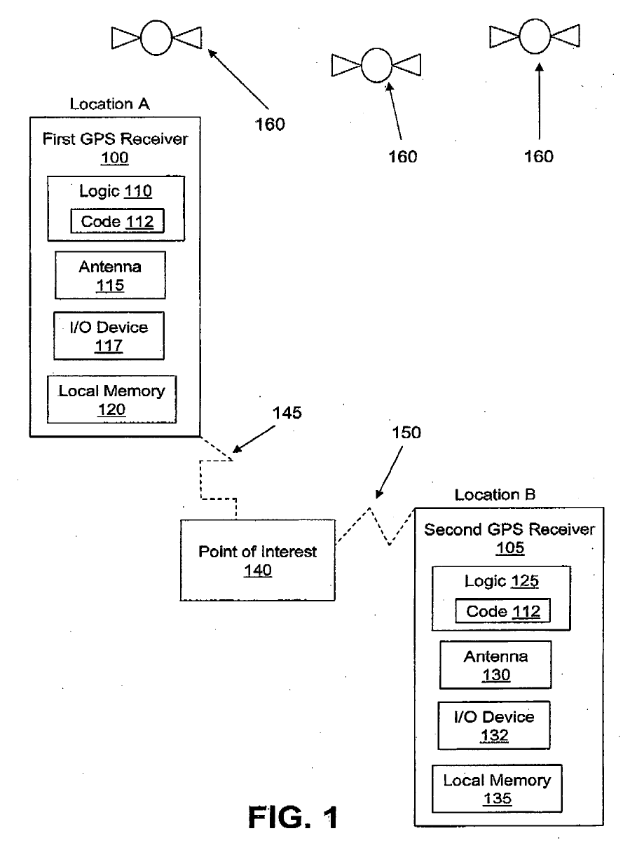

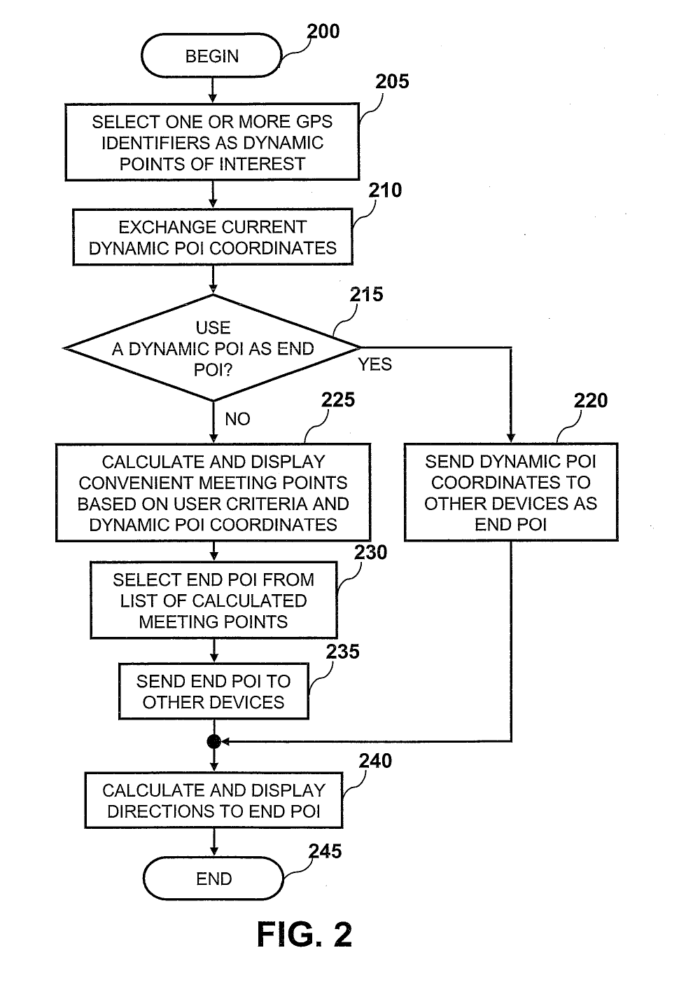

With reference now to FIG. 1, there is depicted a high level block diagram of first GPS receiver 100 and second GPS receiver 105 in relation to POI 140, according to an embodiment of the present invention. As shown, first GPS receiver 100 includes logic 110, antenna 115, input/output (I/O) device 117, and local memory 120. Similarly, second GPS receiver 105 includes logic 125, antenna 130, I/O device 132, and local memory 135. Antennas 115 and 130 enable first GPS receiver 100 and second GPS receiver 105, respectively, to receive navigation and time data from multiple satellites 160, and/or to send and receive identification information to other GPS receivers. First GPS receiver 100 and second GPS receiver 105 utilize code 112 within logic 110 and 125, respectively, to calculate coordinates based on the navigation and time data received from the multiple satellites and to perform the functions illustrated in FIG. 2, which is discussed below.

Local memory 120 and local memory 135 store identification information (referred to herein as GPS identifiers) that corresponds to first GPS receiver 100 and second GPS receiver 105, respectively. Local memory 120 and local memory 135 also store one or more additional pre-programmed GPS identifiers that correspond to GPS receivers known to users of first GPS receiver 100 and second GPS receiver 105, respectively. In one embodiment, code 112 within first GPS receiver 100 adds a GPS identifier that corresponds to second GPS receiver 105 to the list of pre-programmed GPS identifiers when first GPS receiver 100 and second GPS receiver 105 connect via a synchronization process and exchange GPS identifiers.

First GPS receiver 100 and second GPS receiver 105 are initially located at different geographic coordinates (e.g., location A and location B). First GPS receiver 100 and second GPS receiver 105 utilize the navigation process illustrated in FIG. 2, which is discussed below, to enable the users of first GPS receiver 100 and second GPS receiver 105 to navigate along paths 145 and 150, respectively, toward a common meeting point (such as POI 140). According to the illustrative embodiment, the meeting point can be a location that is convenient to a majority of the GPS receiver users that correspond to the selected GPS receiver identifiers, or the dynamic location of one of the selected GPS receivers corresponding to the list of pre-programmed GPS identifiers.

Turning now to FIG. 2, there is illustrated a high level logical flowchart of an exemplary method of navigating to a common POI based on the locations of multiple GPS receivers, according to an embodiment of the invention. The process begins at block 200 in response to a user of first GPS receiver 100 (from FIG. 1) initiating a request to meet the users of one or more additional GPS receivers. The user of first GPS receiver 100 selects one or more GPS identifiers from a pre-programmed list of GPS identifiers that correspond to other users of GPS receivers that the user of first GPS receiver 100 would like to meet with, and first GPS receiver 100 defines the selected GPS identifiers as dynamic POIs, as depicted in block 205. First GPS receiver 100 subsequently exchanges current coordinates with the one or more defined dynamic POIs, as shown in block 210.

At block 215, logic 110 determines whether a dynamic POI (i.e., the location of one of the selected GPS receivers) will be utilized as the end POI (i.e., the meeting location), based on user input or pre-defined user criteria. First GPS receiver 100 obtains user input via one or more of I/O device 117, a graphical user interface (GUI), a command line interface, and/or a voice recognition interface. If a dynamic POI will be utilized as the end POI, first GPS receiver 100 sends the coordinates of the selected dynamic POI (i.e., the location of the selected GPS receiver) as the end POI to the other GPS receivers, as shown in block 220. First GPS receiver 100 subsequently continually updates and displays navigational directions to the location of the end POI as the selected dynamic POI moves, as depicted in block 240, and the process terminates at block 245.

If a dynamic POI will not be utilized as the end POI (i.e., the meeting point will not be the location of one of the GPS receivers), first GPS receiver 100 calculates and displays multiple convenient meeting points based on pre-defined user criteria and the dynamic POI coordinates of the one or more other GPS receivers, as shown in block 225. As utilized herein, pre-defined user criteria includes, but is not limited to, change in elevation, proximity to various resources (e.g., coffee houses, restaurants, parks, or night clubs), average estimated traveling time to a meeting point for each GPS receiver, and total road distance from a meeting point to each dynamic POI. First GPS receiver 100 dynamically selects a “best” POI based on the pre-defined user criteria and the coordinates of each dynamic POI, as depicted in block 230. In an alternate embodiment, first GPS receiver 100 prompts a user to select an end POI (i.e., a meeting point) from the calculated list of multiple meeting points. First GPS receiver 100 subsequently sends the coordinates of the selected end POI (i.e., the “best” meeting location for all users) to the other GPS receivers, as shown in block 235. First GPS receiver 100 calculates and displays navigational directions to the location of the end POI, as depicted in block 240, and the process terminates at block 245.

In another embodiment, the user of first GPS receiver 100 may be a meeting coordinator by sending a meeting notice to each attendee (i.e., friends going to happy hour after work), but first GPS receiver 100 may not be the dominant entity during the decision making process, which is described in blocks 225 and 230 above. Each of the users of the multiple GPS receivers that correspond to dynamic POIs may instead wirelessly vote to select an end POI from a list of end POIs presented by a GUI. In yet another embodiment, first GPS receiver 100 may automatically weigh the pre-defined criteria stored within local memory 120 against accessible and/or downloadable pre-defined criteria stored in the GPS receivers of the other users when calculating the multiple convenient meeting points.

The present invention thus provides a method of navigating to a common POI based on the locations of multiple GPS receivers. A user of first GPS receiver 100 (from FIG. 1) selects second GPS receiver 105 from a list of multiple pre-defined GPS receiver identifiers stored within first GPS receiver 100. First GPS receiver 100 exchanges coordinates with second GPS receiver 105. If the location of second GPS receiver 105 is the POI, first GPS receiver 100 calculates and displays navigational directions to the location of second GPS receiver 105. If second GPS receiver 105 is not the POI, first GPS receiver 100 calculates and displays multiple convenient meeting points based on pre-defined meeting preferences. When one of the meeting points is selected, first GPS receiver 100 sends the coordinates of the meeting point to the other GPS receivers, and first GPS receiver 100 calculates and displays navigational directions to the meeting point.

It is understood that the use herein of specific names are for example only and not meant to imply any limitations on the invention. The invention may thus be implemented with different nomenclature/terminology and associated functionality utilized to describe the above devices/utility, etc., without limitation.

In the flow chart (FIG. 2) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While an illustrative embodiment of the present invention has been described in the context of a fully functional GPS receiver with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

1. In a first global positioning system (GPS) receiver, a method comprising:
selecting, at the first GPS receiver, an identifier of a second GPS receiver from among a plurality of pre-defined GPS receiver identifiers stored within said first GPS receiver, wherein selecting said identifier of the second GPS receiver from among said plurality of pre-defined GPS receiver identifiers further comprises identifying said second GPS receiver as a dynamic point of interest (POI);
exchanging location coordinates with said second GPS receiver;
in response to a determination that a location of said second GPS receiver is a desired meeting location;
calculating navigational directions to said location of said second GPS receiver; and
displaying said navigational directions to said location on said first GPS receiver; and
in response to a determination that a different location, other than said location of said second GPS receiver, would be said desired meeting location:
calculating a plurality of convenient meeting points for selection as the desired meeting location based on pre-defined meeting preferences;
simultaneously displaying said plurality of convenient meeting points on said first GPS receiver;
enabling selection of one of said plurality of convenient meeting points as the desired meeting location; and
when one of said plurality of convenient meeting points is selected as said desired meeting location:
sending location coordinates of the selected desired meeting location to said second GPS receiver;
calculating navigational directions to said desired meeting location; and
displaying said navigational directions on said first GPS receiver.

2. (canceled)

3. The method of claim 1, wherein selecting said identifier of the second GPS receiver from among said plurality of pre-defined GPS receiver identifiers further comprises:
selecting one or more additional GPS receiver identifiers from among said plurality of pre-defined GPS receiver identifiers;
identifying said one or more additional GPS receivers as dynamic POIs;
dynamically selecting a best meeting point based on said pre-defined meeting preferences and said location coordinates of said dynamic POIs:
sending said location coordinates of the selected best meeting point to the one or more additional GPS receivers identified by said one or more additional GPS receiver identifiers; and
updating said navigational directions to said meeting point in response to movement of one of said dynamic POIs.

4. (canceled)

5. (canceled)

6. The method of claim 1, further comprising:
automatically adding said second GPS receiver to said plurality of pre-defined GPS receiver identifiers stored within said first GPS receiver in response to a dynamic synchronization process between said first GPS receiver and said second GPS receiver when said first GPS receiver is in proximity to said second GPS receiver and an identifier of said second GPS receiver is not currently one of the plurality of pre-defined GPS receiver identifiers stored within the first GPS receiver.

7. A first global positioning system (GPS) receiver comprising:
a logic unit;
an antenna coupled to said logic unit;
a local memory coupled to said logic unit;
a utility executing on said logic unit and which comprises code for:
selecting, at the first GPS receiver, an identifier of a second GPS receiver from among a plurality of pre-defined GPS receiver identifiers stored within said first GPS receiver, wherein selecting said identifier of the second GPS receiver from among said plurality of pre-defined GPS receiver identifiers further comprises identifying said second GPS receiver as a dynamic point of interest (POI);
exchanging location coordinates with said second GPS receiver;
in response to a determination that a location of said second GPS receiver is a desired meeting location:
calculating navigational directions to said location of said second GPS receiver; and
displaying said navigational directions to said location on said first GPS receiver; and
in response to a determination that a different location, other than said location of said second GPS receiver, would be said desired meeting location:
calculating a plurality of convenient meeting points for selection as the desired meeting location based on pre-defined meeting preferences;
simultaneously displaying said plurality of convenient meeting points on said first GPS receiver;
enabling selection of one of said plurality of convenient meeting points as the desired meeting location; and
when one of said plurality of convenient meeting points is selected as said desired meeting location:
sending location coordinates of the selected desired meeting location to said second GPS receiver when one of said plurality of convenient meeting points is selected as said desired meeting location;
calculating navigational directions to said desired meeting location when one of said plurality of convenient meeting points is selected as said desired meeting location; and
displaying said navigational directions on said first GPS receiver when one of said plurality of convenient meeting points is selected as said desired meeting location.

8. (canceled)

9. The GPS of claim 7, wherein said code for selecting said identifier of the second GPS receiver from among said plurality of pre-defined GPS receiver identifiers further comprises code for:
selecting one or more additional GPS receiver identifiers from among said plurality of pre-defined GPS receiver identifiers;
identifying said one or more additional GPS receivers as dynamic POIs;
dynamically selecting a best meeting point based on said pre-defined meeting preferences and said location coordinates of said dynamic POIs:
sending said location coordinates of the selected best meeting point to the one or more additional GPS receivers identified by said one or more additional GPS receiver identifiers; and
updating said navigational directions to said meeting point in response to movement of one of said dynamic POIs.

10. (canceled)

11. (canceled)

12. The GPS of claim 7, said utility further comprising code for dynamically adding said second GPS receiver to said plurality of pre-defined GPS receiver identifiers stored within said first GPS receiver in response to a dynamic synchronization process between said first GPS receiver and said second GPS receiver when said first GPS receiver is in proximity to said second GPS receiver and an identifier of said second GPS receiver is not currently one of the plurality of pre-defined GPS receiver identifiers stored within the first GPS receiver.

13. A computer program product comprising:
a computer storage medium; and
program code on said computer storage medium that that when executed provides the functions of:
selecting an identifier of a second GPS receiver from among a plurality of pre-defined GPS receiver identifiers stored within said first GPS receiver, wherein selecting said identifier of the second GPS receiver from among said plurality of pre-defined GPS receiver identifiers further comprises identifying said second GPS receiver as a dynamic point of interest (POI);
exchanging location coordinates with said second GPS receiver;
in response to a determination that a location of said second GPS receiver is a desired meeting location:
calculating navigational directions to said location of said second GPS receiver; and
displaying said navigational directions to said location on said first GPS receiver;
enabling selection of said identifier of the second GPS receiver from among said plurality of pre-defined GPS receiver identifiers further comprises code for identifying said second GPS receiver as a dynamic point of interest (POI); and
in response to a determination that a different location, other than said location of said second GPS receiver, would be said desired meeting location:
calculating a plurality of convenient meeting points for selection as the desired meeting location based on pre-defined meeting preferences;
simultaneously displaying said plurality of convenient meeting points on said first GPS receiver; and
when one of said plurality of convenient meeting points is selected as said desired meeting location:
sending location coordinates of said the selected desired meeting location to said second GPS receiver;
calculating navigational directions to said desired meeting location; and
displaying said navigational directions on said first GPS receiver.

14. (canceled)

15. The computer program product of claim 13, wherein said code for selecting said identifier of the second GPS receiver from among said plurality of pre-defined GPS receiver identifiers further comprises code for:
selecting one or more additional GPS receiver identifiers from among said plurality of pre-defined GPS receiver identifiers; and
identifying said one or more additional GPS receivers as dynamic POIs;
dynamically selecting a best meeting point based on said pre-defined meeting preferences and said location coordinates of said dynamic POIs:
sending said location coordinates of the selected best meeting point to the one or more additional GPS receivers identified by said one or more additional GPS receiver identifiers: and
updating said navigational directions to said meeting point in response to movement of one of said dynamic POIs.

16. (canceled)

17. (canceled)

18. The computer program product of claim 13, further comprising code for automatically adding said second GPS receiver to said plurality of pre-defined GPS receiver identifiers stored within said first GPS receiver in response to a dynamic synchronization process between said first GPS receiver and said second GPS receiver when said first GPS receiver is in proximity to said second GPS receiver and an identifier of said second GPS receiver is not currently one of the plurality of pre-defined GPS receiver identifiers stored within the first GPS receiver.
